(19) United States
(12) Patent Application Publication
(10) Pub. No.: US 2003/0132204 A1
(43) Pub. Date: Jul. 17, 2003

(54) Welding head, nozzle and method for powder plasma arc welding (PPAW)

(76) Inventor: Renzo Bouwe Van de Plas, Apeldoorn (NL)

Correspondence Address: SWANSON & BRATSCHUN L.L.C., 1745 SHEA CENTER DRIVE, SUITE 330, HIGHLANDS RANCH, CO, 80129, US

(21) Appl. No.: 10/240,005

(22) PCT Filed: Mar. 28, 2001
(86) PCT No.: PCT/NL01/00256

(30) Foreign Application Priority Data
Mar. 28, 2000 (NL) 1014770

(51) Int. Cl. B23K 10/00

(52) U.S. Cl. 219/121.45; 219/121.5

(57) ABSTRACT

A welding head for powder plasma arc welding (PPAW), comprising an electrode and a supporting jacket arranged coaxially around the electrode with inclusion of a first feed channel, in which supporting jacket an inner nozzle is received, such that the first feed channel extends in an axial flow direction along the electrode via a bore in the inner nozzle as far as a first outflow opening situated in an end face of the inner nozzle. The welding head further comprises an outer nozzle arranged coaxially around the supporting jacket, which outer nozzle surrounds the supporting jacket with inclusion of a second feed channel, such that the second feed channel, axially converging in the flow direction, extends as far as a second outflow opening. The welding head has a characteristic feature that the supporting jacket extends in the flow direction beyond the inner nozzle, such that the end face of the inner nozzle is situated upstream with respect to the end face of the supporting jacket. The invention further relates to an inner nozzle for a welding head and to a method for powder plasma arc welding.

The invention relates to a welding head for powder plasma arc welding (PPAW welding), comprising an electrode and a supporting jacket arranged coaxially around the electrode with inclusion of a first feed channel, in which supporting jacket an inner nozzle is received, such that the first feed channel extends in an axial flow direction along the electrode via a bore in the inner nozzle as far as a first outflow opening situated in an end face of the inner nozzle; further comprising an outer nozzle arranged coaxially around the supporting jacket, which outer nozzle surrounds the supporting jacket with inclusion of a second feed channel, such that the second feed channel, axially converging in the flow direction, extends as far as a second outflow opening.

Such a welding head is known and is used for Powder Plasma Arc Welding (PPAW welding).

In PPAW welding, a potential difference is generated between an electrode and a workpiece, and an inert gas stream is guided along the electrode, so that a plasma arc is struck between the workpiece and the electrode. Around the first gas stream, further, a shield-shaped second gas stream, in which metal powder is included, is added, such that the second gas stream intersects the first gas stream. Thus, the metal powder can be melted on the workpiece via the plasma arc.

The addition of metal powder is of importance in particular when a bead is to be provided on the workpiece, or when evaporation of workpiece material as a result of welding is to be compensated. Further, the addition of powder is of importance to enhance the weldability of particular alloyed metals. What can further be achieved through the addition of powder is that the weld can achieve a desired width. This is especially of importance in fillet welds, which, with a view to strength, must have a prescribed width.

Compared with more traditional welding processes, in which, for instance, a welding wire is added, PPAW welding has the advantage that, by the very absence of the wire, the orientation of the welding head with respect to the workpiece can be freer. As a consequence, the PPAW welding process lends itself well for automation by means of an industrial manipulator or welding robot. Further, when welding is carried out manually, the welder can have one hand free, and the welder can have a better view of the workpiece. In addition, during welding, materials can be added which are not available as rod stock.

In the known welding head, the first gas stream is passed through the first feed channel and the second gas stream is passed through the second, axially converging, feed channel, such that the second gas stream intersects the first gas stream. To prevent disturbance of the second gas stream, in the known welding head, the end face of the inner nozzle is made of convex design and the end face of the inner nozzle reaches beyond the supporting jacket. The end face then extends outside through an opening in the end face of the supporting jacket.

A problem presenting itself in PPAW welding is that particles of the (metal) powder from the second gas stream, during supply, adhere to the end face of the inner nozzle. This is the case in particular when metal powder is supplied which has a low melting point, such as zinc or aluminum. This effect is further enhanced when the inner nozzle, as is usual, is made of metal, for instance copper, and when the inner nozzle is increased in temperature by the heat of the plasma arc.

Through adhesion of the powder particles, unevennesses are formed on the end face of the inner nozzle, so that the second gas stream is disturbed. Further, when the particles adhere adjacent the first outflow opening, the first gas stream, when exiting, is disturbed as well.

Disturbance of the gas streams can lead to instability of the plasma arc and even to short-circuiting.

As a consequence of the above-mentioned disadvantages, the PPAW process is insufficiently stable for (metal) powders having a relatively low melting point, that is, a melting point lower than 850° C., in particular in the interval of 500° to 800° C., resulting in a weld of unpredictable quality and a relatively short tool life of the inner nozzle.

The object of the invention is to provide a welding head of the type mentioned in the opening paragraph hereof, in which the above-mentioned problems are avoided. To that end, the welding head according to the invention is characterized in that the supporting jacket extends in the flow direction beyond the inner nozzle, such that the end face of the inner nozzle is situated upstream with respect to the end face of the supporting jacket. What is thereby achieved is that the end face of the inner nozzle is situated inwards with respect to the end face of the supporting jacket, so that the end face of the inner nozzle is screened and adhesion of powder particles to the end face is prevented. Surprisingly, an inner nozzle having such a receded end face does not cause any adverse turbulence. The second gas stream is then screened from the inner nozzle, such that the second gas stream with the powder intersects the first gas stream only downstream of the end face of the inner nozzle.

What is achieved by the application of the above-mentioned features is that when (metal) powder of a relatively low melting point, such as aluminum or zinc, is fed to the welding head, adhesion of the powder to the end face of the inner nozzle is prevented. As a result, a weld of a predictable quality can be made and the tool life of the inner nozzle can be prolonged considerably. In particular, the PPAW process, even when (metal) powder of a low melting point is supplied, can be performed with a manipulator or industrial robot.

To further avoid adhesion of powder particles to the end face of the inner nozzle, the end face can be made of substantially flat or even concave design.

Further advantageous embodiments of the invention are described in the subclaims.

The invention also relates to an inner nozzle for a welding head, and to a method for powder plasma arc welding.

The invention will be further elucidated on the basis of an exemplary embodiment represented in the drawing. In the drawing:

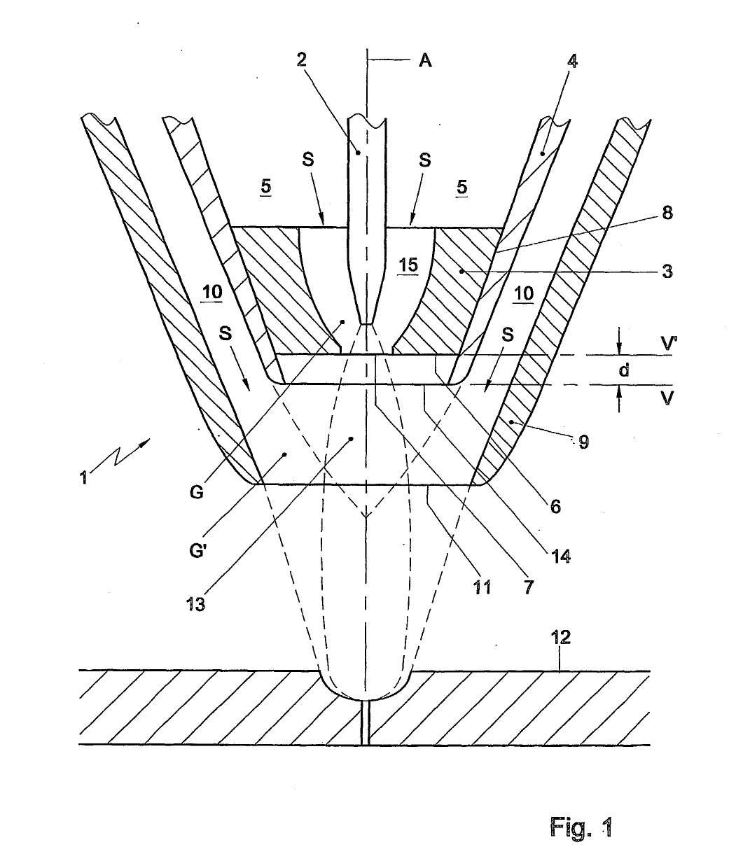

FIG. 1 shows a schematic cross section of a first embodiment of the welding head according to the invention;

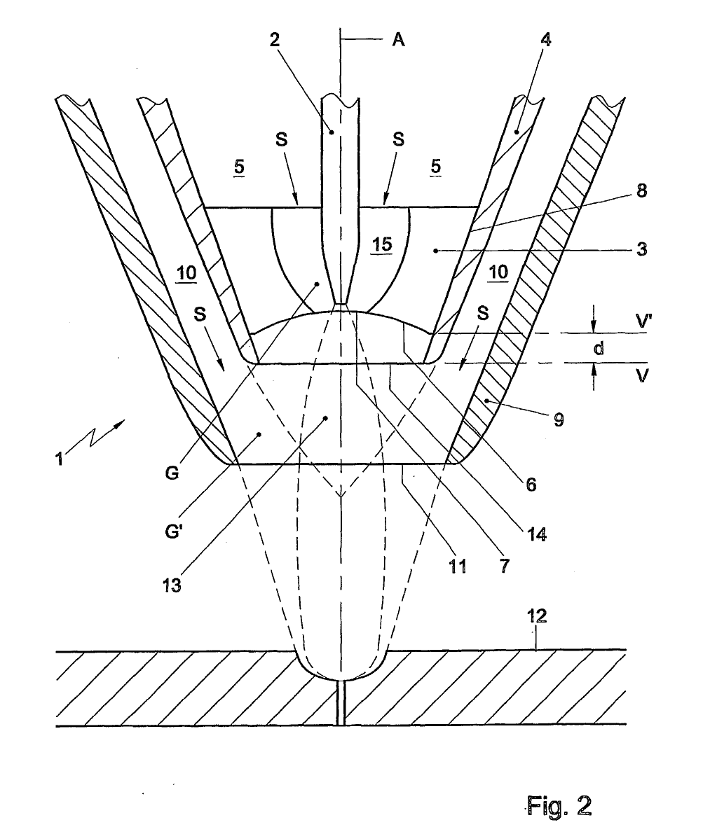

FIG. 2 shows a schematic cross section of a second embodiment of the welding head according to the invention.

In the figures, the same or corresponding parts are designated by the same reference numerals. The figures are only schematic representations of preferred embodiments of the invention.

FIG. 1 shows a welding head 1 for powder plasma arc welding (PPAW). The welding head 1 comprises an electrode 2 and a supporting jacket 4 arranged around the electrode 2, coaxially with respect to the centerline A of the welding head, thereby enclosing a first feed channel 5. In the supporting jacket 4 an inner nozzle 3 is received, such that the first feed channel 5 extends in an axial flow direction S along the electrode 2 via a bore 15 in the inner nozzle 3 as far as a first outflow opening 7 situated in the end face 6 of the inner nozzle 3. The welding head 1 further comprises an outer nozzle 9 arranged coaxially around the supporting jacket 4 and surrounding the supporting jacket 4 with inclusion of a second feed channel 10. The second feed channel 10, axially converging in the flow direction, extends as far as a second outflow opening 11 situated beyond the end face 14 of the supporting jacket. The outer nozzle 9 is designed as a tapering cylindrical shell.

The inner nozzle 3 is designed as a tapering cylinder. The inner nozzle 3 is detachably received in the supporting jacket 4, for instance through clamping. The supporting jacket 4 and the inner nozzle are manufactured from copper. The supporting jacket 4 and the outer nozzle 9 are connected with a heat exchanger, for instance a water-cooled coil, to remove heat from the inner nozzle 3 through conduction, and to prevent overheating of the inner nozzle 3 by the plasma arc 13.

The electrode 2, the supporting jacket 4 and the outer nozzle 9 are attached to a central supporting head, not shown. Preferably, the outer nozzle 9 and the electrode 2 are detachably connected with the supporting head, such that not only the inner nozzle 3 but also the electrode 2 and the outer nozzle 9 can be replaced.

The supporting jacket 4 extends in the flow direction S beyond the inner nozzle 3, such that the end face 6 of the inner nozzle 3 is situated upstream with respect to the end face 14 of the supporting jacket 4. In FIG. 1 this is shown by way of the plane V′ through the end face 6 of the inner nozzle 3 which is situated a distance d upstream of the plane V through the end face 14 of the supporting jacket 4.

Referring to FIG. 2, there is shown a second embodiment of the welding head 1, in which the end face 6 of the outer nozzle 3 is substantially concave and recedes upstream as far as the first outflow opening 7. It is noted that the end face 14 can also be of concave design.

The overall construction of the welding head for PPAW welding will not be further discussed here, since it is known to those skilled in the art. A suitable welding head for PPAW welding is the PPAW torch marketed by the firm of Plasma Modules OY in Finland.

During use of the welding head 1, a potential difference is applied between the electrode 2 and a workpiece 12. A first inert gas stream G, for instance argon, is passed through the first feed channel 5, so that a plasma arc 13 egressing from the first outflow opening 7 is formed between the workpiece 12 and the electrode 2. Around the first gas stream G, a second, inert gas stream G′ in the form of a shield is added via the second feed channel 10. The second gas stream G′ exits via the second outflow opening 11 and is provided with added metal powder. The second gas stream G′ comprises, for instance, argon to which particles of aluminum powder have been added. The size of the particles of metal powder is then preferably between 100 and 250 μm. The melting point of the particles of (metal) powder can be relatively low, preferably lower than 850° C., in particular in the interval 500° C.-800° C.

Due to the end face 6 of the inner nozzle 3 being situated axially upstream with respect to the end face 14 of the supporting jacket 4, the second gas stream G′ can be screened from the end face 6 of the inner nozzle 3, such that the second gas stream G′ intersects the first gas stream G downstream of the end face 6 of the inner nozzle. This prevents the second gas stream G′ coming into contact with the end face 6 of the inner nozzle 3, so that adhesion of powder particles to the end face 6 of the inner nozzle 3 is avoided.

What is achieved in that the end face 6 extends substantially transversely to the centerline of the welding head is that the distance d between the end faces of the inner nozzle and the supporting jacket, compared with a convex end face 6, can be relatively great.

The details of the PPAW process, such as the setting of the process parameters, will not be further discussed here, since they are known to those skilled in the art, in particular from the manual of Plasma Modules OY, of Finland, regarding the above-mentioned PPAW torch.

It will be clear that the invention is not limited to the exemplary embodiments discussed here. In particular, the first and the second feed channels can consist of separate parts, and the first feed channel can axially have a constant diameter and/or a widening diameter. Further, the shape of the inner nozzle and the end face thereof can be different, and the inner nozzle can be manufactured from non-metal such as ceramics.

Such variants will be clear to those skilled in the art and are understood to fall within the scope of the invention as set forth in the following claims.

1. A welding head for powder plasma arc welding (PPAW), comprising an electrode and a supporting jacket arranged coaxially around the electrode with inclusion of a first feed channel, in which supporting jacket an inner nozzle is received, such that the first feed channel extends in an axial flow direction along the electrode via a bore in the inner nozzle as far as a first outflow opening situated in an end face of the inner nozzle; further comprising an outer nozzle arranged coaxially around the supporting jacket, which outer nozzle surrounds the supporting jacket with inclusion of a second feed channel, such that the second feed channel, axially converging in the flow direction, extends as far as a second outflow opening, characterized in that the supporting jacket extends in the flow direction beyond the inner nozzle, such that the end face of the inner nozzle is situated upstream with respect to the end face of the supporting jacket.

2. A welding head according to claim 1, characterized in that the end face of the inner nozzle is substantially flat and extends substantially transversely to the axial direction.

3. A welding head according to claim 1, characterized in that the end face of the inner nozzle is substantially concave and recedes upstream as far as the first outflow opening.

4. A welding head according to any one of the preceding claims, characterized in that the inner nozzle is detachably connected with the supporting jacket.

5. An inner nozzle for a welding head according to any one of the preceding claims, comprising a cylinder extending, preferably tapering, as far as a flat or concave end face, and having a bore extending along the centerline as far as an outflow opening situated in the end face.

6. A method for powder plasma arc welding (PPAW welding), wherein a potential difference is generated between an electrode and a workpiece, and wherein an inert gas flow is guided along the electrode, so that a plasma arc exiting from an outflow opening situated in an end face of an inner nozzle is formed between the workpiece and the electrode, while, further, around the first gas stream, a shield-shaped second, inert gas stream, in which powder is included, is added, such that the second gas stream intersects the first gas stream, characterized in that the second gas stream is screened from the inner nozzle, such that the second gas stream with the powder intersects the first gas stream downstream of the end face of the inner nozzle.
